(19) United States
(12) Patent Application Publication
(10) Pub. No.: US 2012/0008005 A1
(43) Pub. Date: Jan. 12, 2012

(54) IMAGE PROCESSING APPARATUS, IMAGE PROCESSING METHOD, AND COMPUTER-READABLE RECORDING MEDIUM HAVING IMAGE PROCESSING PROGRAM RECORDED THEREON

(75) Inventor: Munenori Fukunishi, Tokyo (JP)

(73) Assignee: OLYMPUS CORPORATION, Tokyo (JP)

(21) Appl. No.: 13/176,292

(22) Filed: Jul. 5, 2011

(30) Foreign Application Priority Data
Jul. 7, 2010 (JP) 2010-154927

(51) Int. Cl. G06K 9/03; H04N 5/228

(52) U.S. Cl. 348/222.1; 382/309; 348/E05.031

(57) ABSTRACT

A plurality of images are combined while suppressing a luminance change and the occurrence of artifacts. An image processing apparatus includes a measurement-area setting section that sets, in each of a plurality of images to be combined, a motion-vector measurement area that is used to measure at least one motion vector; a calculation section that calculates the motion vector between the images, in the motion-vector measurement area set by the measurement-area setting section; a reliability calculation section that calculates the reliability of the motion vector; and an image composition section that corrects misalignment between the images based on the motion vector and combines the images based on a composition ratio for each pixel, determined based on a feature quantity between the images for the pixel and the reliability of the motion vector.

### BACKGROUND OF THE INVENTION

1. Field of the Invention

The present invention relates to an image processing apparatus, an image processing method, and a computer-readable recording medium having an image processing program recorded thereon.

This application is based on Japanese Patent Application No. 2010-154927, the contents of which are incorporated herein by reference.

2. Description of Related Art

Known conventional technologies for obtaining a desired composite image by combining a plurality of images acquired by a digital still camera includes noise reduction processing, electronic image stabilization (image addition system), and dynamic range expansion processing. Noise reduction processing is a technology for reducing noise that occurs at random, mainly by combining a plurality of images that are acquired with the same exposure conditions. Electronic image stabilization (image addition system) is a technology in which a plurality of images are acquired with separate exposures at a high shutter speed at which camera shaking does not occur, and the images are combined while correcting misalignment of the images, thereby obtaining an image with no blurring. Dynamic range expansion processing is a technology for obtaining a high-dynamic-range image by combining a plurality of images acquired with different exposure conditions.

In the technologies for combining a plurality of images, as described above, there is a possibility that artifacts, such as a double line, occur in the composite image when camera shaking or subject movement occurs at the time of photographing. As a method of resolving this problem, a method of reducing the composition ratio at a pixel where the difference in the value of gradation is large, in an image processing apparatus that combines images while correcting misalignment between the images, is proposed in Japanese Unexamined Patent Application, Publication No. 2008-099260, for example. Furthermore, a method of controlling composition according to a residual error (the absolute value of signal difference or the sum of absolute differences in signal difference) is proposed in Japanese Unexamined Patent Application, Publication No. 2005-039533.

### BRIEF SUMMARY OF THE INVENTION

In the methods described in the above-described known documents, even if alignment of the images is not properly performed, the images are combined when the gradation values of the images are close, and, therefore, even images that cannot be associated with each other because occlusion occurs due to the movement of the subject are combined when the signals have similar gradation between the images. Furthermore, when recursive composition processing in which a composition result and a new image are combined in order to combine a plurality of images is performed, the luminance and color of the composite image are gradually changed from those of the images before composition as the number of images to be added is increased.

The present invention provides an image processing apparatus, an image processing method, and a computer-readable recording medium having an image processing program recorded thereon, in which a plurality of images are combined while suppressing a change in luminance and the occurrence of artifacts.

A first aspect of the present invention is an image processing apparatus including: a measurement-area setting section that sets, in each of a plurality of images to be combined, a motion-vector measurement area that is used to measure at least one motion vector; a calculation section that calculates the motion vector between the images, in the motion-vector measurement area set by the measurement-area setting section; a reliability calculation section that calculates a reliability of the motion vector; and an image composition section that corrects misalignment between the images based on the motion vector and combines the images based on a composition ratio for each pixel, determined based on a feature quantity between the images for the pixel or each area and the reliability of the motion vector.

A second aspect of the present invention is an image processing apparatus including: an image acquisition section that acquires a plurality of images while changing exposure time for photographing; a normalization processing section that normalizes the magnitudes of signal values of pixels of the images based on the ratio of the exposure time; a measurement-area setting section that sets, in each of the images after normalization, a motion-vector measurement area that is used to measure at least one motion vector; a calculation section that calculates the motion vector between the images, in the motion-vector measurement area; a reliability calculation section that calculates a reliability of the motion vector; and an image composition section that corrects misalignment between the images based on the motion vector and combines the images based on a composition ratio for each pixel, determined based on a feature quantity between the images for the pixel or each area, the signal intensities of the images to be combined, and the reliability of the motion vector.

A third aspect of the present invention is an image processing method including: a first process of setting, in each of a plurality of images to be combined, a motion-vector measurement area that is used to measure at least one motion vector; a second process of calculating the motion vector between the images, in the motion-vector measurement area; a third process of calculating a reliability of the motion vector; and a fourth process of correcting misalignment between the images based on the motion vector and combining the images based on a composition ratio for each pixel, determined based on a feature quantity between the images for the pixel or each area and the reliability of the motion vector.

A fourth aspect of the present invention is a computer-readable recording medium having recorded thereon an image processing program for causing a computer to execute: first processing of setting, in each of a plurality of images to be combined, a motion-vector measurement area that is used to measure at least one motion vector; second processing of calculating the motion vector between the images, in the motion-vector measurement area; third processing of calculating a reliability of the motion vector; and fourth processing of correcting misalignment between the images based on the motion vector and combining the images based on a composition ratio for each pixel, determined based on a feature quantity between the images for the pixel or each area and the reliability of the motion vector.

A fifth aspect of the present invention is an image processing method including: a first process of acquiring a plurality of images while changing exposure time for photographing; a second process of normalizing the magnitudes of signal values of pixels of the images based on the ratio of the exposure time; a third process of setting, in each of the images after normalization, a motion-vector measurement area that is used to measure at least one motion vector; a fourth process of calculating the motion vector between the images, in the motion-vector measurement area; a fifth process of calculating a reliability of the motion vector; and a sixth process of correcting misalignment between the images based on the motion vector and combining the images based on a composition ratio for each pixel, determined based on a feature quantity between the images for the pixel or each area, the signal intensities of the images to be combined, and the reliability of the motion vector.

A sixth aspect of the present invention is a computer-readable recording medium having recorded thereon an image processing program for causing a computer to execute: first processing of acquiring a plurality of images while changing exposure time for photographing; second processing of normalizing the magnitudes of signal values of pixels of the images based on the ratio of the exposure time; third processing of setting, in each of the images after normalization, a motion-vector measurement area that is used to measure at least one motion vector; fourth processing of calculating the motion vector between the images, in the motion-vector measurement area; fifth processing of calculating a reliability of the motion vector; and sixth processing of correcting misalignment between the images based on the motion vector and combining the images based on a composition ratio for each pixel, determined based on a feature quantity between the images for the pixel or each area, the signal intensities of the images to be combined, and the reliability of the motion vector.

### BRIEF DESCRIPTION OF THE SEVERAL VIEWS OF THE DRAWINGS

FIG. 1 is a block diagram showing, in outline, the configuration of an image processing apparatus according to a first embodiment of the present invention.

FIG. 2 is a functional block diagram showing an example configuration of a composition processing section according to the first embodiment of the present invention.

FIGS. 3A and 3B are diagrams showing example arrangements of alignment processing areas.

FIG. 4 is an operation flow in an image composition section according to the first embodiment of the present invention.

FIGS. 5A and 5B are diagrams for explaining a method of calculating a motion vector of a composition area, used by the image composition section.

FIG. 6 is a diagram showing an example relationship between the reliability of the motion vector and a composition-ratio weight coefficient.

FIG. 7 is a diagram showing an example relationship between an inter-image feature quantity and a composition-ratio coefficient.

FIG. 8 is an operation flow in an image composition section of an image processing apparatus according to a second embodiment of the present invention.

FIG. 9 is a diagram showing an example relationship between the reliability of the motion vector and an inter-image feature-quantity weight coefficient.

FIG. 10 is a diagram showing an example relationship between a normalized inter-image feature quantity and a composition ratio.

FIG. 11 is an operation flow in an image composition section of an image processing apparatus according to a third embodiment of the present invention.

FIGS. 12A and 12B are diagrams showing example relationships between the inter-image feature quantity according to the magnitude of the reliability of the motion vector and the composition ratio.

FIG. 13 is a functional block diagram showing an example configuration of a composition processing section of an image processing apparatus according to a fourth embodiment of the present invention.

FIG. 14 is an operation flow in an image composition section of the image processing apparatus according to the fourth embodiment of the present invention.

FIG. 15 is a diagram showing an example relationship between the signal intensities of composition target images and a composition switching coefficient.

### DETAILED DESCRIPTION OF THE INVENTION

The present invention is applied to electronic devices that depend on an electric current or electromagnetic field in order to operate properly, such as a digital camera, a digital video camera, and an endoscope. In the embodiments, a description will be given of a case where the present invention is applied to a digital camera, for example.

### First Embodiment

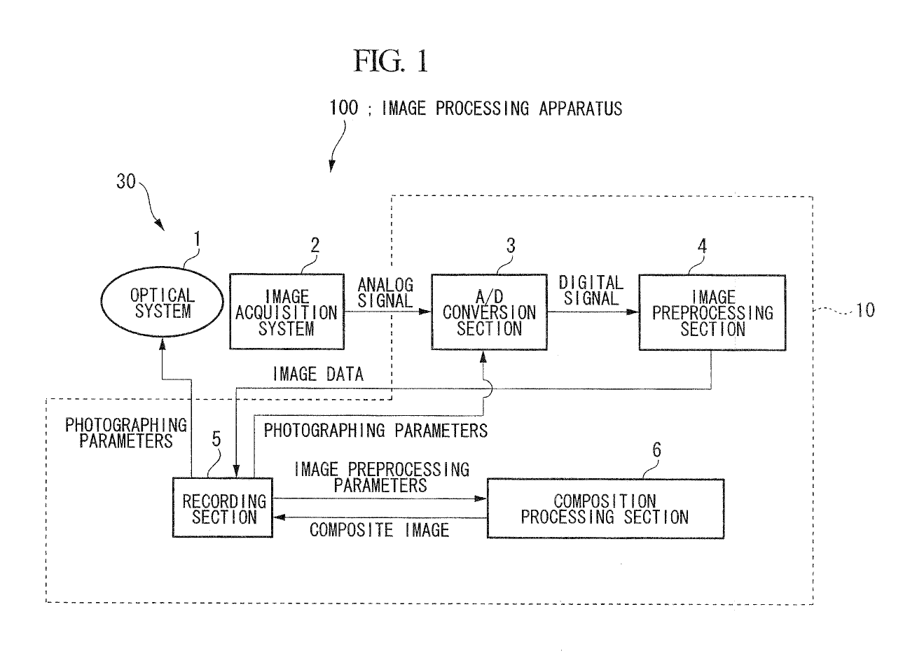

A first embodiment of the present invention will be described using FIGS. 1 to 7. In this embodiment, a description will be given of an example case where an image composition section is used for noise reduction processing in which a plurality of images are combined. In FIG. 1, an image processing apparatus 100 includes an image acquisition section 30 and an image processing section 10.

The image acquisition section 30 includes, for example, an optical system 1 that forms a subject image and an image acquisition system 2 that applies photoelectric-conversion to the optical subject image formed by the optical system 1 and outputs an electrical image signal (hereinafter, the image corresponding to the image signal is referred to as “input image”).

The image processing section 10 includes an analog/digital conversion section (hereinafter referred to as “A/D conversion section”) 3, an image preprocessing section 4, a recording section 5, and a composition processing section 6.

The A/D conversion section 3 converts an analog input image signal into a digital image signal and outputs the digital image signal to the image preprocessing section 4. The image preprocessing section 4 corrects the input digital signal, applies processing, such as mosaicing, to the image signal, and stores the image signal in the recording section 5. The input image signal stored in the recording section 5 is read by the composition processing section 6 at predetermined timing, and a composite image output from the composition processing section 6 is stored in the recording section 5.

Photographing parameters, such as the focal length, the shutter speed, and the aperture (f-number), stored in the recording section 5 are set in the optical system 1, and photographing parameters, such as the ISO sensitivity (gain of A/D conversion), stored in the recording section 5 are set in the A/D conversion section 3. Light collected by the optical system 1 is converted into an electrical signal and is output as an analog signal by the image acquisition system 2.

In the A/D conversion section 3, the analog signal is converted into a digital signal. In the image preprocessing section 4, the digital signal is converted into image data that has been subjected to denoising and demosaicing processing (processing for single-plane to three-plane conversion), and the image data is stored in the recording section 5.

A series of the processes described above is performed for each image acquisition, and, in a case of consecutive image acquisition, the above-described data processing is performed the same number of times as the number of images consecutively acquired. In the composition processing section 6, a composite image is generated based on the image data of a plurality of images and image processing parameters (for example, the image size, the number of alignment templates, and the search range) stored in the recording section 5 and is output to the recording section 5.

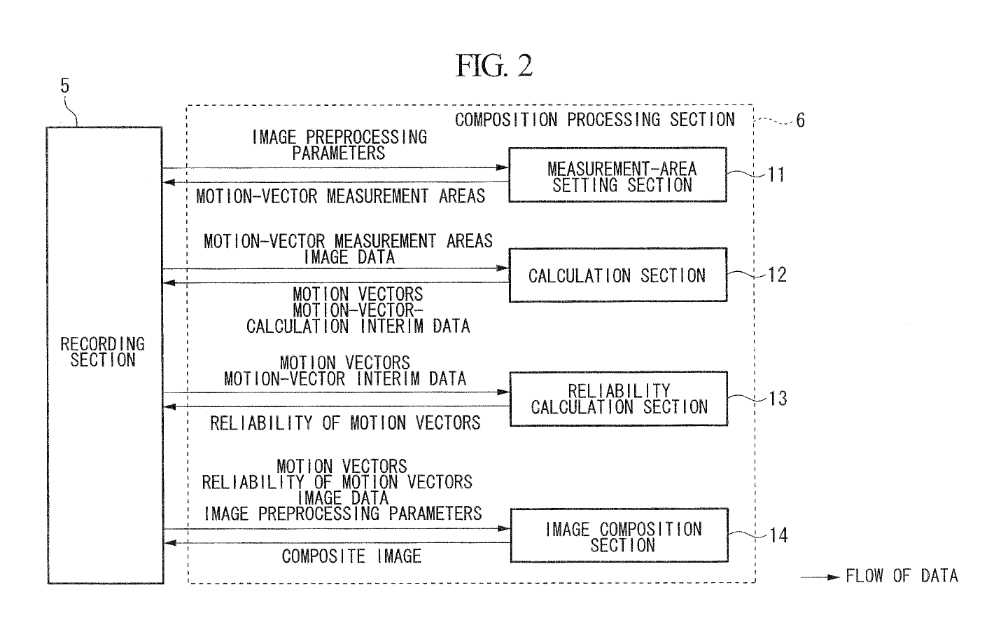

As shown in FIG. 2, the composition processing section 6 includes a measurement-area setting section 11, a calculation section 12, a reliability calculation section 13, and an image composition section 14.

The measurement-area setting section 11 sets, in each of a plurality of images, motion-vector measurement areas that are used to measure at least one motion vector between the images.

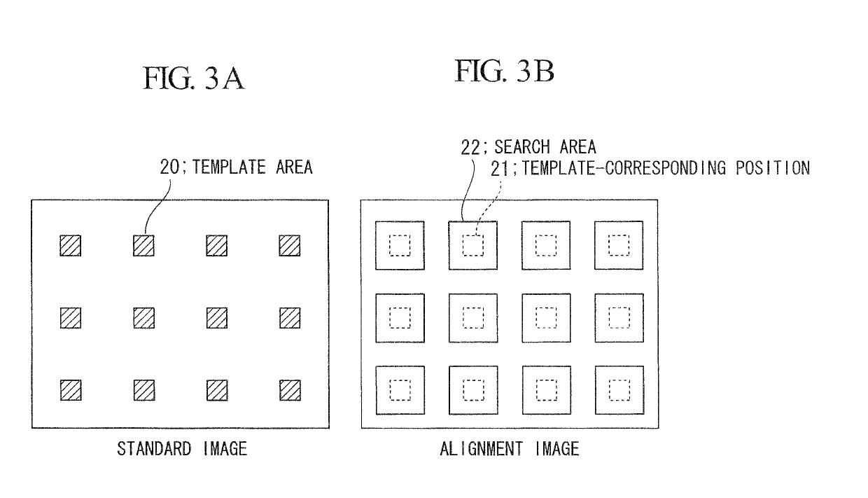

FIGS. 3A and 3B show example arrangements of areas used for image alignment processing. The measurement-area setting section 11 sets two images to be aligned as a standard image and an alignment image, for example. The standard image (see FIG. 3A) is an image in which the coordinate system is not changed after alignment, and a plurality of template areas 20 serving as standard motion-vector measurement areas are arranged.

The alignment image (see FIG. 3B) is an image in which misalignment with respect to the coordinate system of the standard image is corrected, and search areas 22 serving as motion-vector measurement areas for template-corresponding positions 21 corresponding to the template areas 20 of the standard image are arranged in the vicinities of the template-corresponding positions 21. The measurement-area setting section 11 sets the above-described template areas 20 and search areas 22 as the motion-vector measurement areas.

The calculation section 12 calculates motion vectors between the plurality of images, in the motion-vector measurement areas set by the measurement-area setting section 11. Specifically, the calculation section 12 calculates the motion vectors by performing template matching processing based on the standard image and the alignment image. More specifically, the calculation section 12 calculates index values by scanning the template areas 20 of the standard image in the search areas 22 of the alignment image and sets misalignment quantities obtained when the index values become the highest or the lowest, as the motion vectors.

For example, each index value can be calculated by using a known technique, such as the sum of absolute differences, the sum of square differences, or a correlation value. Further, the calculation section 12 outputs, together with the calculated motion vectors, the index values in template matching as interim data calculated during the process of calculating the motion vectors.

The reliability calculation section 13 calculates the reliability of the calculated motion vectors. Specifically, the reliability calculation section 13 calculates the reliability of the motion vectors based on the obtained motion vectors and interim data of the motion vectors. In the above-described template matching processing, it is difficult to stably calculate accurate motion vectors in image areas, such as a low-contrast area and a repeating pattern area, and, therefore, the reliability of the motion vectors is calculated in order to evaluate the calculated motion vectors. For example, the reliability calculation section 13 calculates the reliability of the motion vectors by using the following characteristics (A) to (C).

(A) In areas where the edge structure is sharp, the reliability of the motion vectors is set high. Furthermore, in the areas where the edge structure is sharp, there are significant differences between the index values in the template matching corresponding to the calculated misalignment quantities and those corresponding to the other misalignment quantities. (B) In the case of a texture or a flat structure, there are slight differences in index value in the template matching between when misalignment can be removed and when misalignment remains. (C) In the case of a repetitive structure, the index value in the template matching fluctuates periodically.

Note that the reliability of the motion vectors can be any index as long as it can detect a low-contrast area or a repeating pattern area, and an index that is obtained based on the amount of edges in each block can be used, as described in the Publication of Japanese Patent No. 3164121, for example.

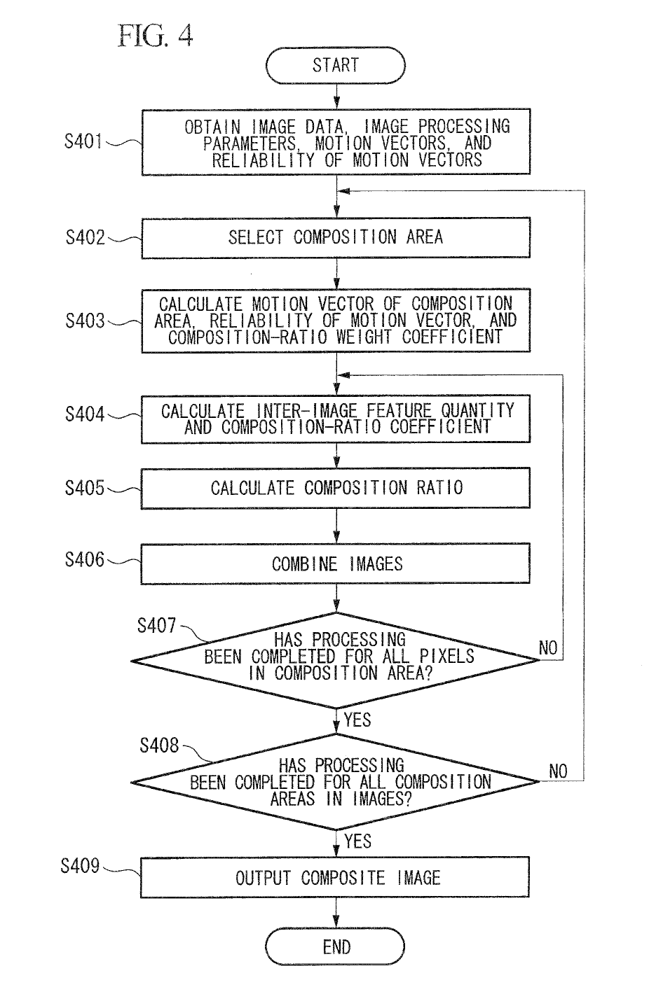

The image composition section 14 corrects the misalignment between the plurality of images based on the motion vectors and combines the plurality of images based on the composition ratio for each pixel, determined based on the feature quantity for each pixel between the plurality of images, and the reliability of the motion vectors. For example, the image composition section 14 corrects the misalignment between the plurality of images based on the motion vectors, performs ratio control such that composition is suppressed for pixels where the feature quantity is large, performs ratio control such that composition is suppressed for areas where the reliability of the motion vector is low, and combines the images based on these ratios. Further, in the image composition processing of the image composition section 14, the images are combined while image misalignment is being corrected in each small area of the images. The specific operation of the image composition section 14 will be described below using FIGS. 4 to 7.

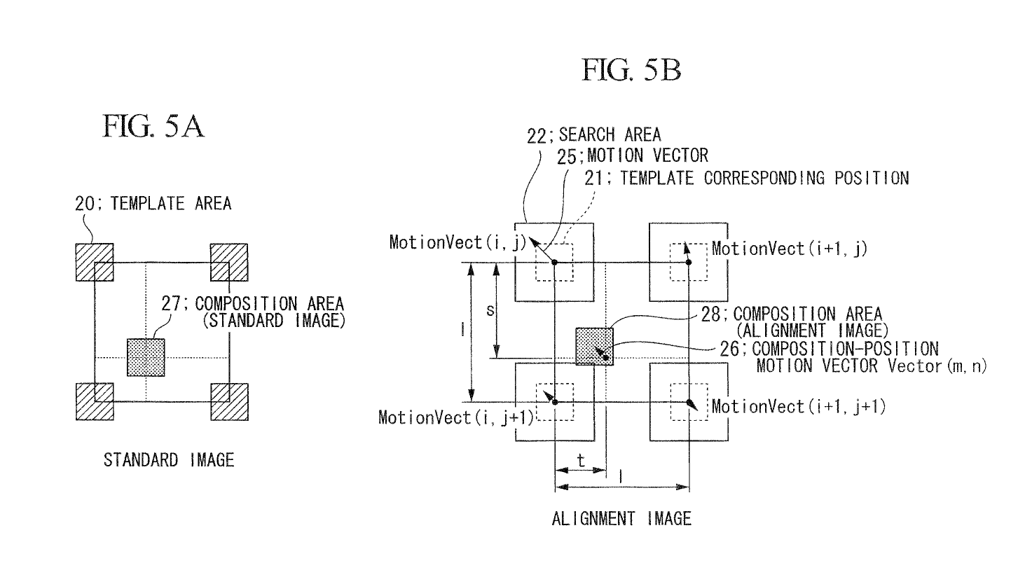

The image data, the image processing parameters, the motion vectors, and the reliability of the motion vectors are obtained (Step S401). In the standard image shown in FIG. 5A, a composition area 27 (the above-described small area) where image composition processing is performed is selected (Step S402), and the motion vector of the area, the reliability of the motion vector, and a composition-ratio weight coefficient are calculated (Step S403). In the alignment image shown in FIG. 5B, motion vectors 25 that are located in the vicinities of the position corresponding to the composition area 27 of the standard image are used, and a composition-position motion vector 26 (Vector (m, n)) is determined in the alignment image by interpolation processing (for example, processing using bi-linear interpolation). Specifically, the motion vector 26 (Vector (m, n)) is determined based on Equation (1).

Vector(m,n)=(1−s)*(1−t)*MotionVect(i,j)+(1−s)*t*MotionVect(i+1,j)+s*(1−t)*MotionVect(i,j+1)+s*t*MotionVect(i+1,j+1) (1)

In FIG. 5B, of four lattice points surrounding a point to be interpolated, the distance between adjacent lattice points is set to “1”, and the vertical distance and the horizontal distance between the starting point of the motion vector (MotionVector(i,j)) at the upper-left lattice point and the starting point of the composition-position motion vector 26 are set to “s” and “t”, respectively. Note that, in this embodiment, bi-linear interpolation is used for interpolation processing; however, the interpolation method is not limited thereto. For example, any interpolation method, such as bi-cubic interpolation and a nearest-neighbor algorithm, can be used instead.

Furthermore, in the alignment image, an area shifted from the position corresponding to the composition area 27 of the standard image by the determined composition-position motion vector 26 is set as a composition area 28 of the alignment image. The reliability of the motion vector is calculated in the same way through the interpolation processing by using the reliability of the motion vectors 25 located in the vicinities of the composition position.

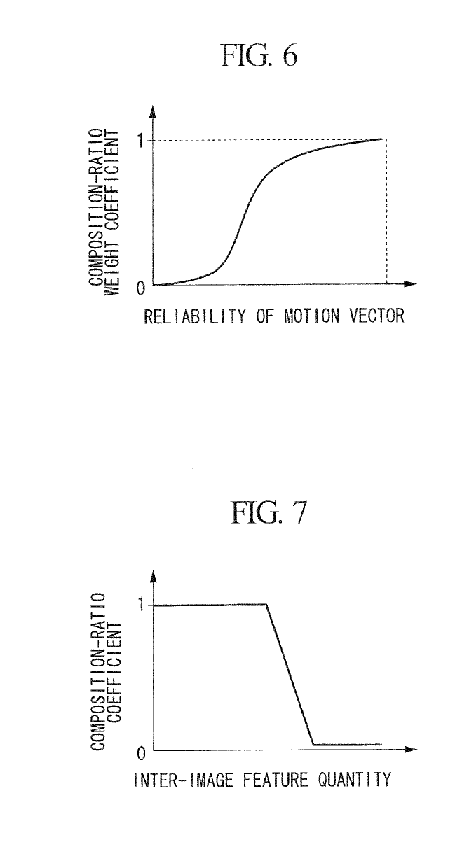

The composition-ratio weight coefficient is determined based on the above-described calculated reliability of the motion vector. For example, in the case when a table of the first association information is set which includes the reliability of the motion vector in the horizontal axis and the composition-ratio weight coefficient in the vertical axis as shown in FIG. 6, the composition-ratio weight coefficient corresponding to the reliability of the motion vector is read from the first association information. Furthermore, the first association information is prescribed such that the composition-ratio weight coefficient is set higher as the reliability of the motion vector becomes higher (right side in the figure), and the composition-ratio weight coefficient is set lower as the reliability thereof becomes lower (left side in the figure).

Next, the inter-image feature quantity indicating the difference (or the degree of matching) between the images is calculated for each pixel or each area, and the composition-ratio coefficient is calculated based on the inter-image feature quantity (Step S404). For example, the inter-image feature quantity is determined by using at least one of: the difference between the images in at least one of luminance, color difference, hue, value, saturation, signal value, G signal value, the first derivatives of the luminance, the color difference, the hue, the value, the saturation, the signal value, and the G signal value, and the second derivatives of the luminance, the color difference, the hue, the value, the saturation, the signal value, and the G signal value; the absolute value of at least one of the above-described difference; the sum of absolute values of at least one of the above-described differences; and the sum of squares of at least one of the above-described differences. In this case, it is judged that the degree of matching between the images becomes higher as the value of the inter-image feature quantity becomes smaller.

Note that the inter-image feature quantity may be determined by using a correlation value in at least one of luminance, color difference, hue, value, saturation, signal value, G signal value, the first derivatives of the luminance, the color difference, the hue, the value, the saturation, the signal value, and the G signal value, and the second derivatives of the luminance, the color difference, the hue, the value, the saturation, the signal value, and the G signal value. In this case, it is judged that the degree of matching between the images becomes higher as the value of the inter-image feature quantity becomes larger.

The composition-ratio coefficient is calculated based on the above-described calculated inter-image feature quantity. For example, as shown in FIG. 7, when the horizontal axis indicates the inter-image feature quantity, and the vertical axis indicates second association information showing the composition-ratio coefficient, the composition-ratio coefficient corresponding to the inter-image feature quantity is read from the second association information. Furthermore, the second association information is prescribed such that the composition-ratio coefficient is set low when the inter-image feature quantity is large (that is, when the degree of matching between the images is low), and the composition-ratio coefficient is set high when the inter-image feature quantity is small (that is, when the degree of matching between the images is high).

A composition ratio α for each pixel is calculated based on the above-described calculated composition-ratio weight coefficient and composition-ratio coefficient (Step S405). Specifically, the composition ratio α is calculated based on Equation (2).

α=Rᵣ*R_{w} (2)

α: composition ratio

Rᵣ: composition-ratio coefficient

R_{w}: composition-ratio weight coefficient

The images are combined based on the thus-calculated composition ratio α and Equation (3) (Step S406).

Value=(Value_{std}+Value_{align}*α)/(1+α) (3)

Value: composition pixel value

Value_{std}: pixel value of standard image

Value_{align}: pixel value of alignment image

α: composition ratio

It is determined whether the above-described processing has been completed for all pixels in the composition area 27 of the standard image and the composition area 28 of the alignment image (Step S407). If the processing has not been completed for all pixels, the flow returns to Step S404, and the processing is repeated. If the processing has been completed for all pixels, it is determined whether the processing has been completed for all composition areas 27 and 28 in the images (Step S408). If the processing has not been completed for all composition areas, the flow returns to Step S402, and the processing is repeated. If the processing has been completed for all composition areas, the generated composite image is output (Step S409), and this processing ends.

In this way, in the above-described composition processing, when the reliability of the motion vector is low, the composition-ratio weight coefficient is set low, and, thus, the composition ratio is also set low. Similarly, when the difference between the images is large, the composition-ratio coefficient is set low, and, thus, the composition ratio is also set low. Therefore, in these cases, composition of the images is suppressed.

Next, the operation of the image processing apparatus according to this embodiment will be described using FIG. 1 to FIG. 3B.

The motion-vector measurement areas, such as the template areas 20 and the search areas 22 for the motion vectors, are set based on the image processing parameters, such as the image size, the number of alignment templates, and the search range. Based on the motion-vector measurement areas and pieces of image data, the motion vectors, which indicate inter-image misalignment, are calculated in the respective motion-vector measurement areas, and the motion vectors and the interim data that is calculated during the process of calculating the motion vectors are output.

Next, the reliability of the respective motion vectors is calculated based on the motion vectors and the motion-vector interim data and is output. In the image composition section 14, based on the above-described calculated motion vectors, the reliability of the motion vectors, the image data, and the image processing parameters, the inter-image misalignment is corrected based on the motion vectors, and the plurality of images are combined based on the composition ratio for each pixel, determined based on the inter-image feature quantity for each pixel and the reliability of the motion vector, and the obtained composite image is output to the recording section 5.

Note that, in this embodiment, the processing is performed by hardware, that is, the image processing apparatus; however, the configuration is not limited thereto. For example, a configuration in which the processing is performed by separate software can also be used. In this case, the image processing apparatus is provided with a CPU, a main memory, such as a RAM, and a computer-readable recording medium having a program for realizing all or part of the above-described processing recorded thereon. Then, the CPU reads the program recorded in the above-described recording medium and executes information processing and calculation processing, thereby realizing the same processing as the above-described image processing apparatus.

The computer-readable recording medium is a magnetic disk, a magneto optical disk, a CD-ROM, a DVD-ROM, a semiconductor memory, etc. Furthermore, the computer program may be delivered to a computer through a communication line, and the computer to which the computer program has been delivered may execute the program.

As described above, according to the image processing apparatus 100, the image processing method, and the image processing program of this embodiment, the inter-image feature quantity is used to perform control such that composition is not performed for pixels where the difference between the images is large, and, in addition, the reliability of the motion vector, which serves as alignment information, is used to perform control such that image composition is not performed for areas where the reliability of alignment is low. Thus, it is possible to suppress the composition of areas that do not correspond to each other and to suppress a luminance change (color change) and the occurrence of artifacts in the composite image.

Note that, in this embodiment, a description has been given of the configuration where the template areas 20 are arranged in the standard image, and the search areas 22 corresponding to the template areas 20 are arranged in the alignment image; however, the configuration is not limited thereto. For example, a configuration may be used in which the template areas 20 are arranged in the alignment image, the search areas 22 are arranged in the standard image, and the signs, that is, the positive and the negative, of the calculated motion vector are switched to obtain the same effects.

### Second Embodiment

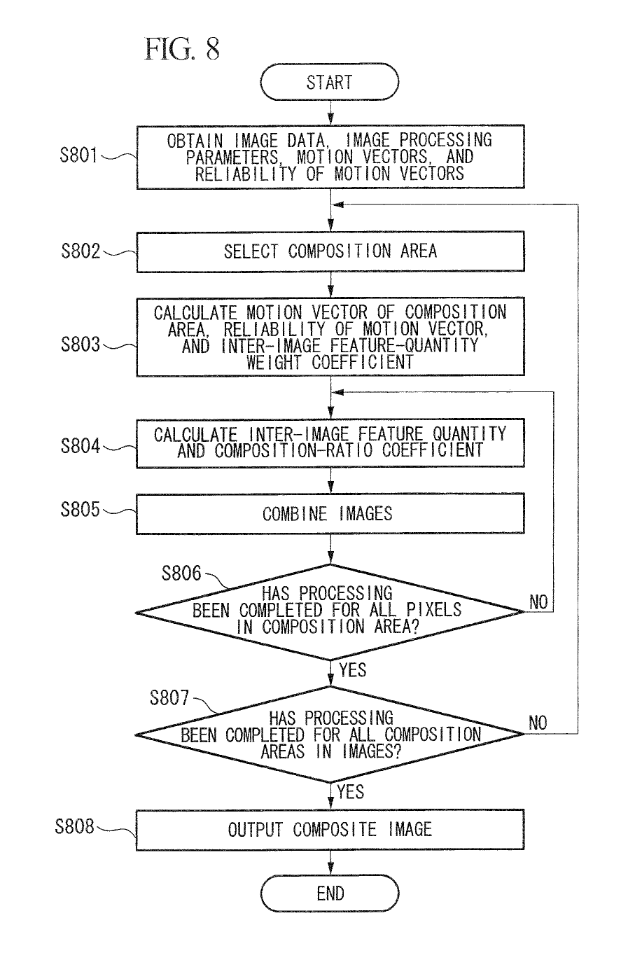

Next, a second embodiment of the present invention will be described using FIGS. 8 to 10.

An image composition section of this embodiment differs from that of the first embodiment in that, whereas the image composition section 14 of the image processing apparatus of the first embodiment performs coefficient control with respect to the reliability of the motion vector such that composition is suppressed for areas where the reliability of the motion vector is low, the image composition section of this embodiment controls the coefficient of the inter-image feature quantity according to the reliability of the motion vector such that composition is suppressed for areas where the reliability of the motion vector is low. An image processing apparatus of this embodiment will be described below mainly in terms of the differences from that of the first embodiment, and a description of similarities will be omitted.

The image composition section corrects misalignment between the plurality of images based on the motion vectors, performs coefficient control such that the inter-image feature quantity is set relatively small for areas where the reliability of the motion vector is high, performs coefficient control such that the inter-image feature quantity is set relatively large for areas where the reliability of the motion vector is low, and combines the images based on these coefficients. Furthermore, in the image composition processing of the image composition section, the images are combined while image misalignment is being corrected in each small area of the images. The specific operation of the image composition section will be described below using FIGS. 8 to 10.

The image data, the image processing parameters, the motion vectors, and the reliability of the motion vectors are obtained (Step S801). A composition area where the image composition processing is to be performed is selected (Step S802), and the motion vector of the area, the reliability of the motion vector, and the inter-image feature-quantity weight coefficient are calculated (Step S803). The method of calculating the motion vector and the reliability of the motion vector is the same as that used in the above-described first embodiment.

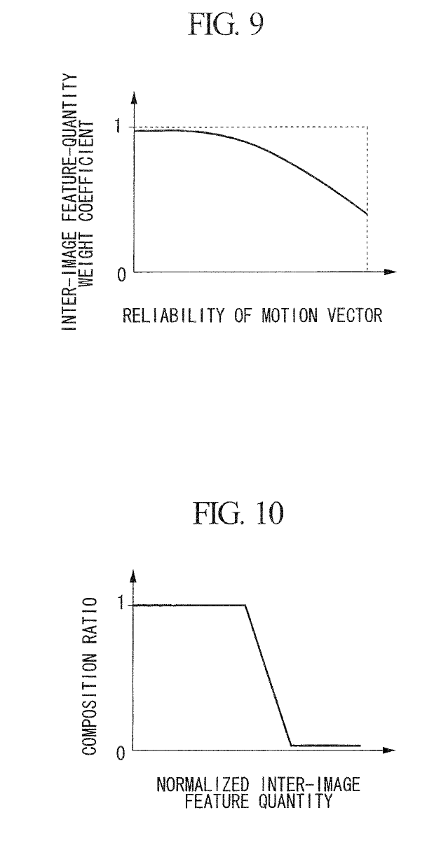

The inter-image feature-quantity weight coefficient is determined based on the above-described calculated reliability of the motion vector. For example, as shown in FIG. 9, when the horizontal axis indicates the reliability of the motion vector, and the vertical axis indicates third association information showing the inter-image feature-quantity weight coefficient, the inter-image feature-quantity weight coefficient corresponding to the reliability of the motion vector is read from the third association information to determine the inter-image feature-quantity weight coefficient. Furthermore, the third association information is prescribed such that the inter-image feature-quantity weight coefficient is set smaller as the reliability of the motion vector becomes higher (right side in the figure), and the inter-image feature-quantity weight coefficient is set larger as the reliability thereof becomes lower (left side in the figure).

Next, the inter-image feature quantity and the composition ratio are calculated (Step S804). The inter-image feature quantity is the feature quantity showing the difference (or the degree of matching) between the images and is calculated for each pixel. For example, the inter-image feature quantity is calculated by the sum of absolute differences at neighborhood pixels and may also be calculated by using another feature quantity, as in the above-described first embodiment. Furthermore, the inter-image feature quantity is normalized based on the inter-image feature-quantity weight coefficient and Equation (4).

Feature_{std}=Feature*Weight_{feature} (4)

Feature_{std}: normalized inter-image feature quantity

Feature: inter-image feature quantity

Weight_{feature}: inter-image feature-quantity weight coefficient

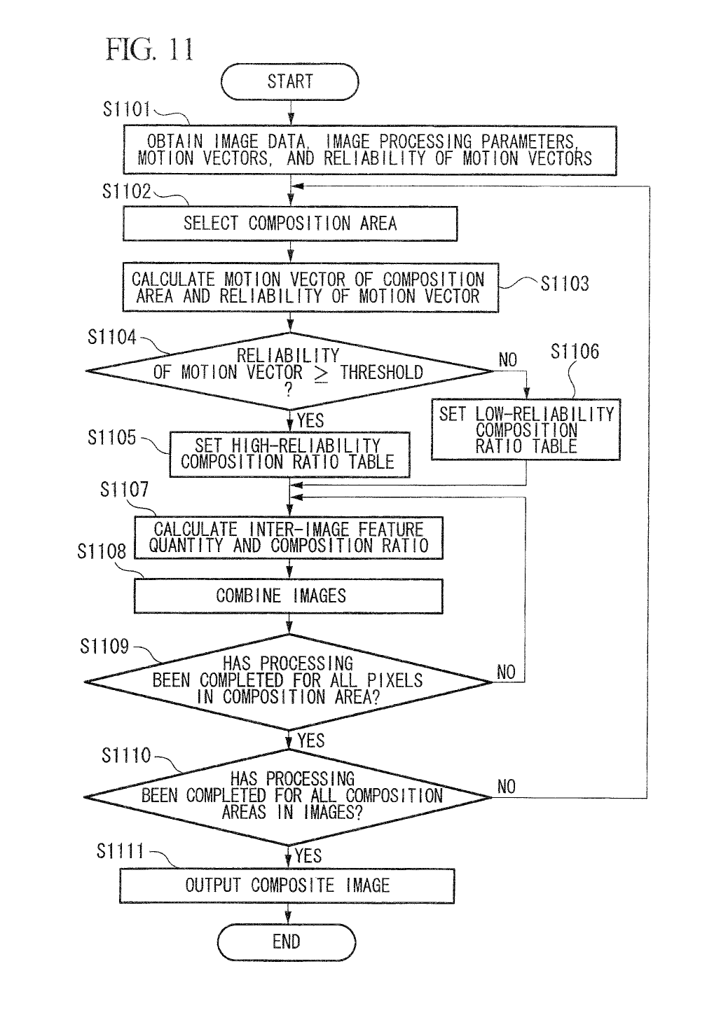

Furthermore, the composition ratio is determined based on the normalized inter-image feature quantity. For example, as shown in FIG. 10, when the horizontal axis indicates the normalized inter-image feature quantity, and the vertical axis indicates fourth association information showing the composition ratio, the composition ratio corresponding to the normalized inter-image feature quantity is read from the fourth association information to determine the composition ratio. Furthermore, the fourth association information is prescribed such that the composition ratio is set smaller as the normalized inter-image feature quantity becomes larger, and the composition ratio is set higher as the normalized inter-image feature quantity becomes smaller and the degree of matching between the images becomes higher. In this way, based on the composition ratio determined based on the inter-image feature quantity, the images are combined using Equation (3), which is also used in the above-described first embodiment (Step S805).

It is determined whether the image composition processing has been completed for all pixels in the composition area (Step S806). If the image composition processing has not been completed for all pixels in the composition area, the flow returns to Step S804. If the image composition processing has been completed for all pixels in the composition area, it is determined whether the image composition processing has been completed for all composition areas in the images (Step S807). If the image composition processing has been completed for all composition areas in the images, the generated composite image is output (Step S808), and this processing ends. If the image composition processing has not been completed for all composition areas in the images (No in Step S807), the flow returns to Step S802, and the processing is repeated.

As described above, according to the image processing apparatus, the image processing method, and the image processing program of this embodiment, for pixels where the difference between the images is large, control is performed such that composition is not performed, and, in addition, coefficient control is applied to the inter-image feature quantity itself in order to set the inter-image feature quantity relatively larger when the reliability of the motion vector is low and to set the inter-image feature quantity relatively smaller when the reliability of the motion vector is high. As a result, image composition is suppressed for areas where the reliability of the motion vector is low. Thus, since composition of areas that do not correspond to each other is suppressed, it is possible to suppress a luminance change (color change) and the occurrence of artifacts in the composite image.

### Third Embodiment

Next, a third embodiment of the present invention will be described using FIGS. 2, 11, and 12B. This embodiment differs from the above-described first and second embodiments in that composition is suppressed for areas where the reliability of the motion vector is low, by using a different coefficient table that is used to control the composition ratio, according to the reliability of the motion vector. An image processing apparatus of this embodiment will be described below mainly in terms of the differences from those of the first and second embodiments, and a description of similarities will be omitted.

The image composition section corrects misalignment between the plurality of images based on the motion vectors, determines the composition ratio using a first coefficient table that is used for a high-reliability composition ratio, for areas where the reliability of the motion vector is high, determines the composition ratio using a second coefficient table that is used for a low-reliability composition ratio, for areas where the reliability of the motion vector is low, and combines the images based on these determined composition ratios. The specific operation of the image composition section will be described below using FIG. 11.

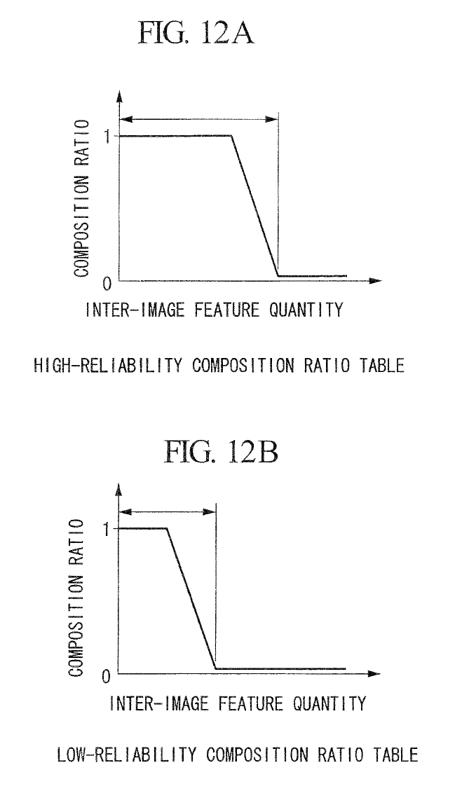

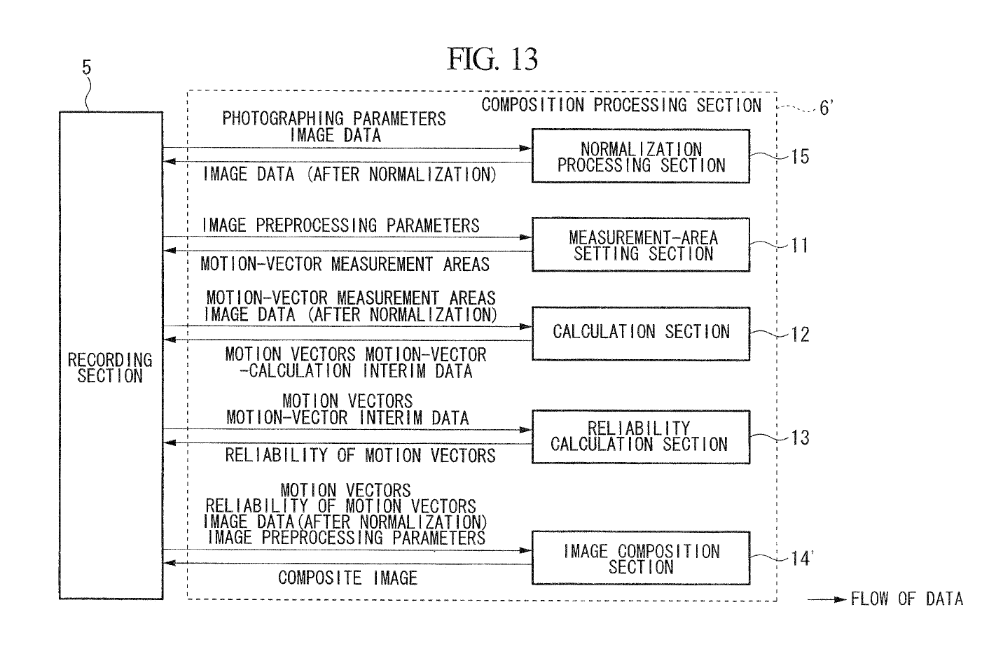

The image data, the image processing parameters, the motion vectors, and the reliability of the motion vectors are obtained (Step S1101). A composition area where the image composition processing is to be performed is selected (Step S1102), and the motion vector of the area and the reliability of the motion vector are calculated (Step S1103). The calculated reliability of the motion vector is compared with a predetermined threshold (Step S1104). If the reliability of the motion vector is equal to or larger than the predetermined threshold, the first coefficient table (see FIG. 12A), which is a high-reliability composition ratio table, is selected (Step S1105). If the reliability of the motion vector is smaller than the predetermined threshold, the second coefficient table (see FIG. 12B), which is a low-reliability composition ratio table, is selected (Step S1106).

In FIGS. 12A and 12B, the horizontal axis indicates the inter-image feature quantity, and the vertical axis indicates the composition ratio. The low-reliability composition ratio table (the second coefficient table) shown in FIG. 12B is prescribed such that, compared with the high-reliability composition ratio table (the first coefficient table) shown in FIG. 12A, the composition ratio with respect to the inter-image feature quantity is set smaller or the composition ratio with respect to the inter-image feature quantity rapidly drops.

The inter-image feature quantity showing the difference (or the degree of matching) between the images is calculated for each pixel, and the composition ratio is determined based on the inter-image feature quantity, the first coefficient table, and the second coefficient table (Step S1107). The images are combined based on the calculated composition ratio and Equation (3), described above (Step S1108).

It is determined whether the image composition processing has been completed for all pixels in the composition area (Step S1109). If the image composition processing has not been completed for all pixels in the composition area, the flow returns to Step S1107. If the image composition processing has been completed for all pixels in the composition area, it is determined whether the image composition processing has been completed for all composition areas in the images (Step S1110). If the image composition processing has been completed for all composition areas, the generated composite image is output (Step S1111), and this processing ends. If the image composition processing has not been completed for all composition areas in the images (No in Step S1110), the flow returns to Step S1102, and the processing is repeated.

As described above, according to the image processing apparatus, the image processing method, and the image processing program of this embodiment, the tables used to determine the composition ratio are selectively used according to the magnitude of the reliability of the motion vector, and, when the reliability of the motion vector is low, compared with when the reliability of the motion vector is high, the composition ratio is set smaller or the composition ratio is set so as to rapidly drop with respect to the inter-image feature quantity, thereby making it possible to further suppress the composition for areas where the reliability of the motion vector is low. Therefore, it is possible to suppress a luminance change (color change) and the occurrence of artifacts in the composite image.

### Fourth Embodiment

Next, a fourth embodiment of the present invention will be described using FIG. 1 and FIGS. 13 to 15.

In the above-described first to third embodiments, a description has been given of an example case where the image composition section of the present invention is used for the noise reduction processing; however, the fourth embodiment differs from the above-described first to third embodiments in that a description will be given of an example case where the image composition section of the present invention is used for dynamic range expansion processing.

In the dynamic range expansion processing, a plurality of images that are acquired while changing an exposure condition, such as a shutter speed, are combined, thereby expanding the dynamic range. For example, in a long-exposure image acquired at a low shutter speed, a dark section can be made brighter when the image is acquired, but saturation occurs in a bright section in some cases. On the other hand, in a short-exposure image acquired at a high shutter speed, the entire image is dark, but saturation is unlikely to occur in a bright section. By combining these images, a high-dynamic-range image having information of both the bright section and the dark section can be obtained. An image processing apparatus of this embodiment will be described below mainly in terms of the differences from those of the first to third embodiments, and a description of similarities will be omitted.

FIG. 13 shows a processing configuration of a composition processing section 6′ of the image processing apparatus of this embodiment. The composition processing section 6′ further includes a normalization processing section 15 in addition to the configuration of the composition processing section of the above-described first embodiment.

The normalization processing section 15 obtains the photographing parameters and image data, normalizes the magnitudes of signal values of pixels in the images by using the ratio of the exposure condition, and outputs the normalized image data. The composition processing section 6′ performs the following processing based on the image data normalized by the normalization processing section 15.

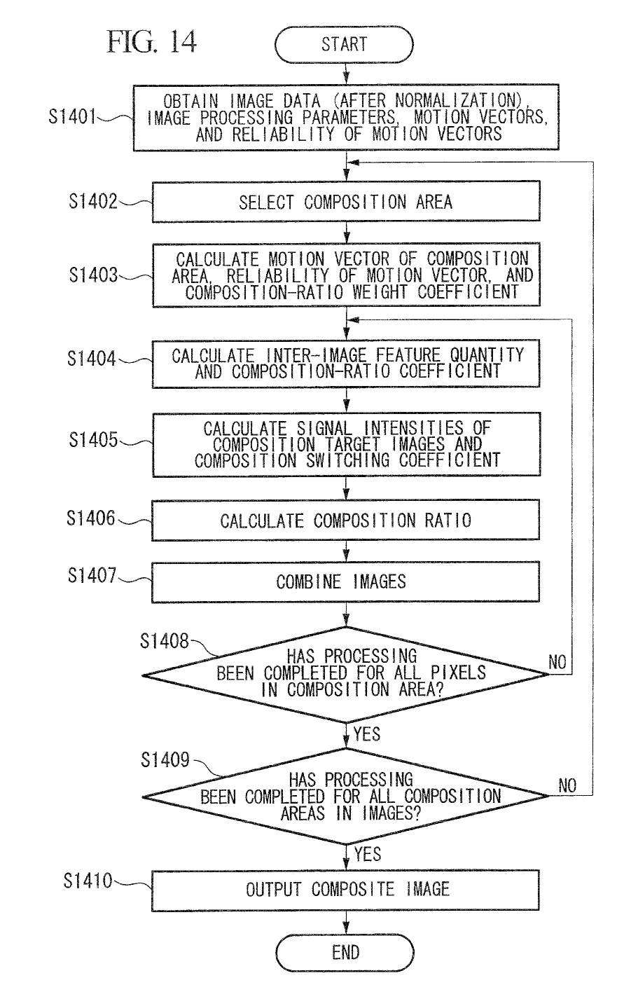

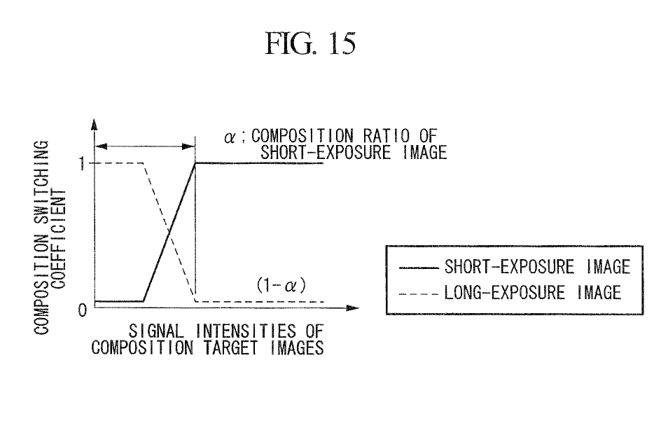

The image composition section 14′ combines the images while correcting calculated inter-image misalignment. Further, the image composition section 14′ is provided with a table (see FIG. 15) prescribing the composition ratio (hereinafter referred to as “composition switching coefficient”) with respect to the signal intensities of a short-exposure image and a long-exposure image. The specific operation of the image composition section 14′ will be described below using FIG. 14.

The normalized image data, the image processing parameters, the motion vectors, and the reliability of the motion vectors are obtained (Step S1401). A composition area where the image composition processing is to be performed is selected (Step S1402), and the motion vector of the area, the reliability of the motion vector, and a composition-ratio weight coefficient are calculated (Step S1403). At this time, the composition-ratio weight coefficient is prescribed so as to be set smaller when the reliability of the motion vector is low, as shown in FIG. 6. Further, the inter-image feature quantity showing the difference (or the degree of matching) between the images is calculated for each pixel, and the composition-ratio coefficient corresponding to the inter-image feature quantity is calculated based on the diagram showing the relationship between the inter-image feature quantity and the composition-ratio coefficient (diagram in which the composition-ratio coefficient is set smaller when the degree of matching between the images is low) shown in FIG. 7 (Step S1404).

Then, the composition switching coefficient is determined based on the signal intensities of pixels for which composition is performed (Step S1405). In FIG. 15, the horizontal axis indicates the signal intensities of composition target images, and the vertical axis indicates a composition switching coefficient. As shown in FIG. 15, the relationship between the signal intensities of the composition target images and the composition switching coefficient is prescribed such that the composition switching coefficient of the long-exposure image is set larger when the signal intensities of the composition target positions becomes low, and the composition switching coefficient of the short-exposure image is set larger when the signal intensities of the composition target positions becomes high. The signal intensity may be an image signal value, an image luminance value, or a G signal value, or may be a combination of them.

The composition ratio is calculated based on the above-described calculated composition-ratio weight coefficient, composition-ratio coefficient, and composition switching coefficient, and Equation (5) (Step S1406).

α_{hdr}=Rᵣ*R_{w}*Rₛ (5)

α_{hdr}: composition ratio of short-exposure image

Rᵣ: composition-ratio coefficient

R_{w}: composition-ratio weight coefficient

Rₛ: composition switching coefficient

Further, the images are combined based on the thus-calculated composition ratio and Equation (6) (Step S1407).

Value=Valueₛₕₒᵣₜ*α_{hdr}+Value_{long}*(1−α_{hdr}) (6)

Value: composition pixel value

Valueₛₕₒᵣₜ: pixel value of short-exposure image

Value_{long}: pixel value of long-exposure image

α_{hdr}: composition ratio of short-exposure image

It is determined whether the image composition processing has been completed for all pixels in the composition area (Step S1408). If the image composition processing has not been completed for all pixels in the composition area, the flow returns to Step S1404. If the image composition processing has been completed for all pixels in the composition area, it is determined whether the image composition processing has been completed for all composition areas in the images (Step S1409). If the image composition processing has been completed for all composition areas in the images, the generated composite image is output (Step S1410), and this processing ends. If the image composition processing has not been completed for all composition areas in the images (No in Step S1409), the flow returns to Step S1402, and the processing is repeated.

Next, the operation of the image processing apparatus of this embodiment will be described using FIGS. 13 and 14.

In the normalization processing section 15, the photographing parameters and the image data are obtained, the brightness of the image is normalized based on the ratio of the exposure condition, and the normalized image data is output. In the motion vector measurement-area setting section 11, the motion-vector measurement areas, such as the template areas and the search areas for the motion vectors, are set based on the image processing parameters, such as the image size, the number of alignment templates, and the search range. In the calculation section 12, the inter-image motion vectors are calculated in the respective motion-vector measurement areas based on the motion-vector measurement areas and the normalized image data. The calculated motion vectors and the interim data obtained during the process of calculating the motion vectors are output.

In the reliability calculation section 13, the index values indicating the reliability of the motion vectors are calculated based on the motion vectors and the interim data of the motion vectors and are output as the reliability of the motion vectors. In the image composition section 14, based on the motion vectors, the reliability of the motion vectors, the normalized image data, and the image processing parameters, the images are combined while inter-image misalignment is being corrected, and the generated composite image is output to the recording section 5.

As described above, according to the image processing apparatus, the image processing method, and the image processing program of this embodiment, the composition ratio is switched according to the signal intensities of the images, composition is suppressed when the difference between the images is large, and composition is suppressed for areas where it is determined that the reliability of alignment is low based on the reliability of the motion vector. Thus, even when images acquired with different exposure conditions are combined, it is possible to suppress composition of areas that do not correspond to each other and to suppress the occurrence of artifacts in the composite image.

What is claimed is:

1. An image processing apparatus comprising:
a measurement-area setting section that sets, in each of a plurality of images to be combined, a motion-vector measurement area that is used to measure at least one motion vector;
a calculation section that calculates the motion vector between the images, in the motion-vector measurement area set by the measurement-area setting section;
a reliability calculation section that calculates a reliability of the motion vector; and
an image composition section that corrects misalignment between the images based on the motion vector and combines the images based on a composition ratio for each pixel, determined based on a feature quantity between the images for the pixel or each area and the reliability of the motion vector.

2. An image processing apparatus according to claim 1, wherein the image composition section increases the composition ratio when a degree of matching between the images, which is determined based on the feature quantity between the images, is equal to or larger than a predetermined value and reduces the composition ratio when the degree of matching between the images is smaller than the predetermined value.

3. An image processing apparatus according to claim 1, wherein the image composition section increases the composition ratio when the reliability of the motion vector is equal to or larger than a predetermined value and reduces the composition ratio when the reliability of the motion vector is smaller than the predetermined value.

4. An image processing apparatus according to claim 1, wherein the image composition section calculates the feature quantity between the images using at least one of: the difference between the images in at least one of the values of the each pixel or the each area selected from the group consisting of luminance, color difference, hue, value, saturation and signal value, and first derivatives and second derivatives of the values; the absolute value of the difference; the sum of absolute values of the differences; the sum of squares of the differences; and a correlation value.

5. An image processing apparatus comprising:
an image acquisition section that acquires a plurality of images while changing exposure time for photographing;
a normalization processing section that normalizes the magnitudes of signal values of pixels of the images based on the ratio of the exposure time;
a measurement-area setting section that sets, in each of the images after normalization, a motion-vector measurement area that is used to measure at least one motion vector;
a calculation section that calculates the motion vector between the images, in the motion-vector measurement area;
a reliability calculation section that calculates a reliability of the motion vector; and
an image composition section that corrects misalignment between the images based on the motion vector and combines the images based on a composition ratio for each pixel, determined based on a feature quantity between the images for the pixel or each area, the signal intensities of the images to be combined, and the reliability of the motion vector.

6. An image processing apparatus according to claim 5, wherein the image composition section increases the composition ratio when a degree of matching between the images, which is determined based on the feature quantity between the images, is equal to or larger than a predetermined value and reduces the composition ratio when the degree of matching between the images is smaller than the predetermined value.

7. An image processing apparatus according to claim 5, wherein the image composition section increases the composition ratio when the reliability of the motion vector is equal to or larger than a predetermined value and reduces the composition ratio when the reliability of the motion vector is smaller than the predetermined value.

8. An image processing apparatus according to claim 5, wherein, when the signal intensities of the images are equal to or larger than a predetermined value, the image composition section increases the composition ratio of a short-exposure image, and, when the signal intensities of the images are smaller than the predetermined value, the image composition section reduces the composition ratio of a long-exposure image.

9. An image processing apparatus according to claim 5, wherein the image composition section calculates the feature quantity between the images using at least one of: the difference between the images in at least one of the values of the each pixel or the each area selected from the group consisting of luminance, color difference, hue, value, saturation and signal value, and first derivatives and second derivatives of the values; the absolute value of the difference; the sum of absolute values of the differences; the sum of the squares of the differences; and a correlation value.

10. An image processing apparatus according to claim 5, wherein the image composition section includes, as the signal intensities of the images, the signal values of the images, the luminance values of the images, or both.

11. An image processing method comprising:
a first process of setting, in each of a plurality of images to be combined, a motion-vector measurement area that is used to measure at least one motion vector;
a second process of calculating the motion vector between the images, in the motion-vector measurement area;
a third process of calculating a reliability of the motion vector; and
a fourth process of correcting misalignment between the images based on the motion vector and combining the images based on a composition ratio for each pixel, determined based on a feature quantity between the images for the pixel or each area and the reliability of the motion vector.

12. A computer-readable recording medium having recorded thereon an image processing program for causing a computer to execute:
first processing of setting, in each of a plurality of images to be combined, a motion-vector measurement area that is used to measure at least one motion vector;
second processing of calculating the motion vector between the images, in the motion-vector measurement area;
third processing of calculating a reliability of the motion vector; and
fourth processing of correcting misalignment between the images based on the motion vector and combining the images based on a composition ratio for each pixel, determined based on a feature quantity between the images for the pixel or each area and the reliability of the motion vector.

13. An image processing method comprising:
a first process of acquiring a plurality of images while changing exposure time for photographing;
a second process of normalizing the magnitudes of signal values of pixels of the images based on the ratio of the exposure time;
a third process of setting, in each of the images after normalization, a motion-vector measurement area that is used to measure at least one motion vector;
a fourth process of calculating the motion vector between the images, in the motion-vector measurement area;
a fifth process of calculating a reliability of the motion vector; and
a sixth process of correcting misalignment between the images based on the motion vector and combining the images based on a composition ratio for each pixel, determined based on a feature quantity between the images for the pixel or each area, the signal intensities of the images to be combined, and the reliability of the motion vector.

14. A computer-readable recording medium having recorded thereon an image processing program for causing a computer to execute:
first processing of acquiring a plurality of images while changing exposure time for photographing;
second processing of normalizing the magnitudes of signal values of pixels of the images based on the ratio of the exposure time;
third processing of setting, in each of the images after normalization, a motion-vector measurement area that is used to measure at least one motion vector;
fourth processing of calculating the motion vector between the images, in the motion-vector measurement area;
fifth processing of calculating a reliability of the motion vector; and
sixth processing of correcting misalignment between the images based on the motion vector and combining the images based on a composition ratio for each pixel, determined based on a feature quantity between the images for the pixel or each area, the signal intensities of the images to be combined, and the reliability of the motion vector.

15. An image processing apparatus according to claim 2, wherein the image composition section calculates the feature quantity between the images using at least one of: the difference between the images in at least one of the values of the each pixel or the each area selected from the group consisting of luminance, color difference, hue, value, saturation and signal value, and first derivatives and second derivatives of the values; the absolute value of the difference; the sum of absolute values of the differences; the sum of squares of the differences; and a correlation value.

16. An image processing apparatus according to claim 6, wherein the image composition section calculates the feature quantity between the images using at least one of: the difference between the images in at least one of the values of the each pixel or the each area selected from the group consisting of luminance, color difference, hue, value, saturation and signal value, and first derivatives and second derivatives of the values; the absolute value of the difference; the sum of absolute values of the differences; the sum of squares of the differences; and a correlation value.

17. An image processing apparatus according to claim 8, wherein the image composition section includes, as the signal intensities of the images, the signal values of the images, the luminance values of the images, or both.
